(19) United States
(12) Patent Application Publication
(10) Pub. No.: US 2026/0008277 A1
(43) Pub. Date: Jan. 8, 2026

(54) IMAGE FORMING APPARATUS AND METHOD OF DETECTING EDGE OF RECORDING MEDIUM IN IMAGE FORMING APPARATUS

(71) Applicant: CANON KABUSHIKI KAISHA, Tokyo (JP)

(72) Inventor: Takaya Suto, Kanagawa (JP)

(21) Appl. No.: 19/254,395

(22) Filed: Jun. 30, 2025

(30) Foreign Application Priority Data
Jul. 5, 2024 (JP) 2024-109087

(51) Int. Cl. B41J 11/00; B41J 11/02; B41J 25/00

(52) U.S. Cl. CPC B41J 11/0095; B41J 11/0065; B41J 11/02; B41J 25/001

(57) ABSTRACT

An image forming apparatus has a detection unit having a light-emitting unit and a plurality of light receiving units that detect reflected light of light emitted from the light-emitting unit. The plurality of light receiving units include a first light receiving unit and a second light receiving unit which are arranged to be aligned in a scanning direction of the detection unit, and the apparatus detects an edge of the recording medium based on a first coordinate of position information obtained when a differential signal between a first light reception signal outputted from the first light receiving unit and a second light reception signal outputted from the second light receiving unit becomes greater than or equal to a threshold and a second coordinate of position information obtained when the differential signal becomes less than or equal to the threshold.

### BACKGROUND

### Field of the Disclosure

The present disclosure relates to an image forming apparatus and a method of detecting an edge of a recording medium in the image forming apparatus.

### Description of the Related Art

When borderless printing is performed by an ink-jet type image recording apparatus, there is a problem in that, for example, if the accuracy in detecting an edge of a recording medium such as a sheet is poor, it will result in staining within the apparatus and the occurrence of a margin. A typical method of detecting an edge of a recording medium in an image recording apparatus is as follows. A light-emitting device including an LED and a light-sensitive device for converting an optical signal of a phototransistor or the like into an electric signal are used to detect an edge of a recording medium based on a detection signal generated by light reflected from the recording medium. Detection accuracy of this detection method tends to degrade due to environmental variation such as staining on the recording medium.

Japanese Patent Laid-Open No. H16-182361 describes a calibration method and a medium edge detection device for reducing the influence of environmental variation.

Japanese Patent Laid-Open No. H16-182361 describes a method of detecting a recording medium using a medium sensor including a pair comprising a light-emitting device and a light-sensitive device. When the light-emitting device and light-sensitive device pair is used, if there is environmental variation, such as floating of an edge of the recording medium or external light, occurring during scanning of the recording medium, variation in the detection signal due to a change in the voltage that crosses a threshold cannot be reduced. Therefore, there is a problem in that the edge of the recording medium cannot be detected with high accuracy.

### SUMMARY

Embodiments of the present disclosure eliminate the above-mentioned issues with conventional technology.

A feature of embodiments of the present disclosure is to provide a technique for accurately detecting an edge of a recording medium.

According to embodiments of the present disclosure, there is provided an image forming apparatus, comprising: a detection unit that has a light-emitting unit configured to emit light towards a recording medium and a plurality of light receiving units configured to detect reflected light of the light; and one or more controllers including one or more processors and one or more memories, wherein the one or more controllers are configured to: cause the detection unit to scan in relation to the recording medium; obtain position information of the detection unit which is caused to scan; and detect an edge of the recording medium based on signals from the plurality of light receiving units, wherein the plurality of light receiving units include a first light receiving unit including one or more light-sensitive devices and a second light receiving unit including one or more light-sensitive devices different to those of the first light receiving unit, the first light receiving unit and the second light receiving unit are arranged to be aligned in a scanning direction of the detection unit, when an edge of the recording medium is to be detected, the one or more controllers being configured to: in scanning of the detection unit, detect the edge of the recording medium based on a first coordinate of position information obtained when a differential signal between a first light reception signal outputted from the first light receiving unit and a second light reception signal outputted from the second light receiving unit, which is outputted from a differential amplifier unit, becomes greater than or equal to a threshold and a second coordinate of position information obtained when the differential signal becomes less than or equal to the threshold.

According to embodiments of the present disclosure, there is provided an image forming apparatus, comprising: a detection unit that has a light-emitting unit configured to emit light towards a recording medium and a plurality of light receiving units configured to detect reflected light of the light; and one or more controllers including one or more processors and one or more memories, wherein the one or more controllers are configured to: cause the detection unit to scan in a forward direction and a backward direction in relation to the recording medium; obtain position information of the detection unit which is caused to scan; and detect an edge of the recording medium based on signals from the plurality of light receiving units, wherein the plurality of light receiving units include a first light receiving unit including one or more light-sensitive devices and a second light receiving unit including one or more light-sensitive devices different to those of the first light receiving unit, the first light receiving unit and the second light receiving unit are arranged to be aligned in a scanning direction of the detection unit, and the image forming apparatus further comprises a differential amplifier unit configured to output a differential signal between a first light reception signal outputted from the first light receiving unit and a second light reception signal outputted from the second light receiving unit, and the one or more controllers being configured to: when detecting an edge of the recording medium, switch the first light reception signal and the second light reception signal for differential inputs of the differential amplifier of the first light reception signal outputted from the first light receiving unit and the second light reception signal according to a case where the detection unit scans in the forward direction and a case where the detection unit scans in the backward direction.

According to embodiments of the present disclosure, there is provided a method of detecting an edge of a recording medium in an image forming apparatus having a detection unit that includes a light-emitting unit configured to emit light towards a recording medium, a first light receiving unit including one or more light-sensitive devices, and a second light receiving unit including one or more light-sensitive devices different to those of the first light receiving unit, and that has a plurality of light receiving units configured to detect reflected light of the light, and a scanning unit configured to cause the detection unit to scan in relation to the recording medium, the method comprising: in scanning by the scanning unit, detecting the edge of the recording medium based on a first coordinate indicating a position of the detection unit when a differential signal between a first light reception signal outputted from the first light receiving unit and a second light reception signal outputted from the second light receiving unit becomes greater than or equal to a threshold and a second coordinate indicating a position of the detection unit when the differential signal becomes less than or equal to the threshold, wherein the first light receiving unit and the second light receiving unit are arranged to be aligned in a scanning direction of the detection unit.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a configuration of an image forming apparatus according to an embodiment of the present disclosure.

FIG. 2 is a schematic diagram for describing a recording operation performed by an ink jet recording apparatus according to the embodiment.

FIG. 3 is a diagram illustrating an arrangement of light-sensitive devices of a medium edge detection sensor.

FIGS. 4A and 4B are diagrams for describing a state in which light emitted from a light-emitting device is reflected by a recording medium and a state in which light is reflected by a platen.

FIGS. 5A through 5C are diagrams for describing typical output waveforms when one light-sensitive device detects a reflection of light from a recording medium.

FIG. 6 is a circuit diagram for describing details of the medium edge detection sensor according to the embodiment.

FIG. 7 is a diagram for describing an operation in a case where the medium edge detection sensor according to the embodiment is used, and an example of output waveforms of the medium edge detection sensor.

FIG. 8 is a diagram for describing a method of obtaining an edge of a recording medium from output waveforms of light-sensitive devices 111 and 112 in the embodiment.

FIG. 9 is a circuit diagram for describing a modification example of the medium edge detection sensor according to the embodiment.

FIG. 10 is a diagram for describing an operation in a case where the medium edge detection sensor according to the embodiment is used, and an example of output waveforms of the medium edge detection sensor.

FIG. 11 is a diagram for describing an operation when both edges of a recording medium are detected using the medium edge detection sensor according to the embodiment.

FIG. 12 is a flowchart for describing a process of detecting an edge of a recording medium using the medium edge detection sensor in the image forming apparatus according to the embodiment of the present disclosure.

FIG. 13 is a circuit diagram for describing an example of the medium edge detection sensor according to the embodiment.

FIGS. 14A and 14B are circuit diagrams for describing a configuration of a medium edge detection sensor according to a modification example of the embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

First, terms used in the present embodiment are defined as follows in advance.

### •“Recording (Printing)”

In this specification, the term “record” does not only mean the formation of significant information such as characters and graphics; the significance of what is recorded is irrelevant, and it does not matter whether what is recorded is manifested so that a human can perceive it visually. “Recording (printing)” should be understood to broadly express cases of forming an image, a pattern, or the like on a recording medium and of performing processing of a medium.

### •“Recording Medium”

“Recording medium” should be understood to broadly express not only paper used in typical recording apparatuses, but also things that are capable of receiving ink such as fabrics, plastic films, metal plates, glass, ceramics, wood, leather, and the like.

### •“Ink”

“Ink” should be interpreted broadly similarly to the above-described definition of “recording”, and should be understood to express a medium containing a recording material that, by being applied to a recording medium, can be supplied in the formation of an image, pattern, or the like, or the processing of a recording medium, or the processing of ink. “Ink” has the physical property of being a liquid. The aforementioned “processing of ink” is, for example, coagulation or insolubilization of a colorant within an ink to be applied to a recording medium.

### •“Nozzle”

“Nozzle” should be understood to express an ejection orifice unless otherwise specified particularly. Inside a nozzle, there are a communicating liquid path and an element that generates energy used for ink ejection.

### •“Scan”

In order to perform recording on a recording medium, a recording head scans a recording medium and performs recording. Here, the movement of the recording head during the acceleration/deceleration of the recording head or the movement of the carriage on which the recording head is mounted, which is for recording or is related to the recording, is described as scanning.

### •“Bi-Directional Recording”

“Bi-directional recording” should be understood to express recording while performing a bi-directional operation of the above-described “recording” or “scanning” on or over the paper surface. “Bi-directional scanning”, “reciprocating recording”, “two-way scanning”, and “two-way recording” should be understood to express similar things.

### •“Color Reproduction Range”

“Color reproduction range” is also referred to as “color gamut” or “gamut”. In general, “color reproduction range” refers to a range of reproducible colors in a given color space.

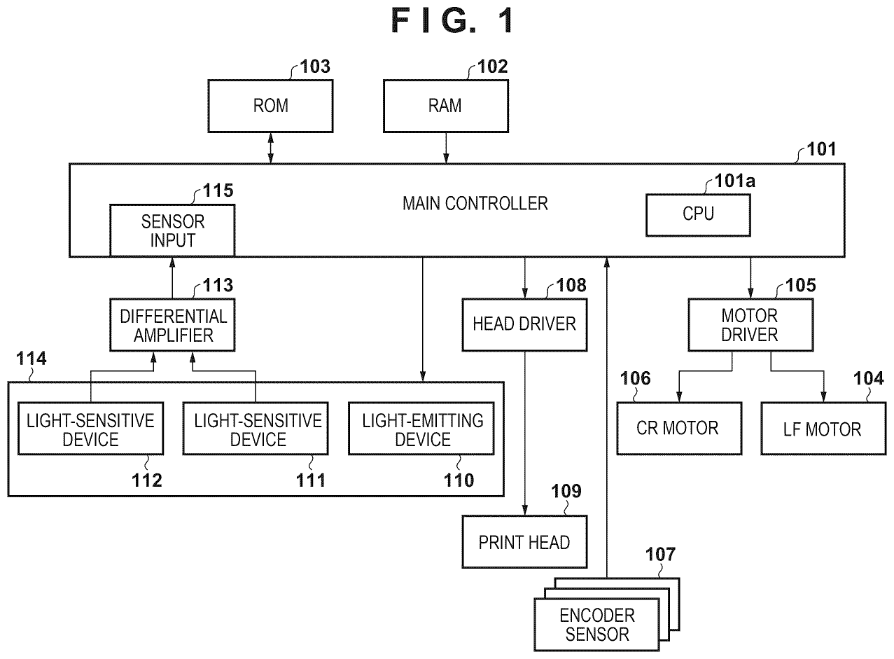

FIG. 1 is a block diagram for describing a configuration of an image forming apparatus according to an embodiment of the present disclosure. Here, the image forming apparatus will be described as an example of an ink jet recording apparatus (hereinafter, also simply referred to as a recording apparatus), but the present disclosure is not limited thereto.

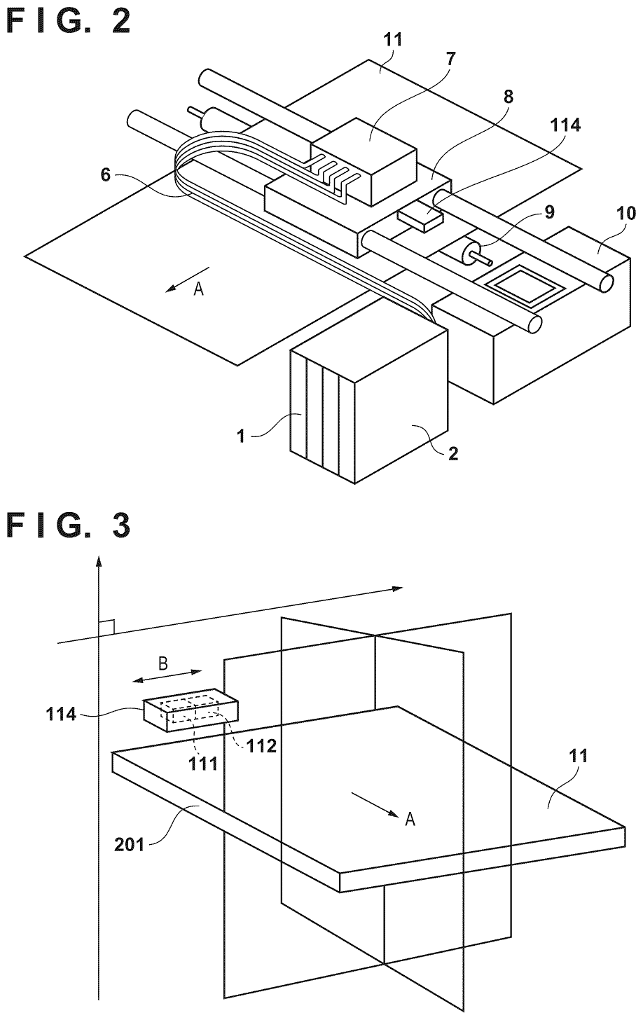

A main controller 101 has a CPU 101a for controlling operation of the main controller 101, and the CPU 101a executes processes according to each of the embodiments described later in accordance with programs stored in a RAM 102 or a ROM 103. The RAM 102 is a volatile storage that temporarily stores programs and data. The ROM 103 is a non-volatile storage that stores programs, parameters, correction data, and the like used in the processes of the embodiments described below. The main controller 101 controls a head driver 108 to drive a print head 109. Further, the main controller 101 controls driving of a plurality of motors via a motor driver 105. The motor driver 105 includes a plurality of motor drivers respectively corresponding to the plurality of motors. One of the plurality of motors is a carriage (CR) motor 106, which is a driving source for driving a scanning unit (hereinafter referred to as a carriage) on which the print head 109 is mounted and that moves bi-directionally left and right. The other is a line feed (LF) motor 104 that drives a recording medium in direction A (FIG. 2). In addition, a motor (not illustrated) is provided for maintenance of the print head 109. Further, the main controller 101 can detect the driving amount of each motor by an encoder sensor 107 corresponding to each motor, and control the driving thereof. An encoder scale read by the encoder sensor 107 may be a linear scale or a rotary scale, but either way it is possible to detect the driving amount of the motor based on a signal (count number) from the sensor. Also, while the encoder sensor 107 is given as a position detection means in FIG. 1, the position detecting means is not limited to the encoder sensor 107.

The main controller 101 is connected to a light-emitting device (light-emitting unit) 110, a light-sensitive device 111, and a light-sensitive device 112 included in an edge detection sensor 114 (hereinafter, also referred to as a medium edge detection sensor 114) of a recording medium, which will be described later. Each of the light-sensitive device 111 and the light-sensitive device 112 constituting the detection unit receives reflected light of the light emitted from the light-emitting device 110 and outputs a photocurrent. The medium edge detection sensor 114 includes the light-emitting device 110 and the light-sensitive devices 111 and 112. Photocurrents from the light-sensitive device 111 and the light-sensitive device 112 are respectively converted into voltage values, are inputted as light reception signals to a differential amplifier (differential amplifier unit) 113, are converted into a differential signal, and the differential signal is inputted into a sensor input 115 of the main controller 101. The main controller 101 obtains an analog input level of the differential signal. Configuration is such that the gain of the differential amplifier 113 can be changed by the main controller 101 in accordance with the levels of the light reception signals.

FIG. 2 is a schematic diagram for describing a recording operation performed by the recording apparatus according to the embodiment.

Ink tanks 1 are detachably attached to an ink tank holder 2 provided in the apparatus main body. The ink tanks 1 each containing one of four colors of pigment-based inks—cyan ink, magenta ink, yellow ink, and black ink—are individually attached to the ink tank holder 2. Each ink tank 1 supplies ink of a respective color to a recording head 7 mounted on a carriage 8 via a supply tube 6. The carriage 8 is equipped with the detachable recording head 7 and the medium edge detection sensor 114. The medium edge detection sensor 114 detects light reflected from a recording medium 11 and thereby detects the edge of the recording medium 11. The principle of detecting an edge of the recording medium 11 will be described in detail later.

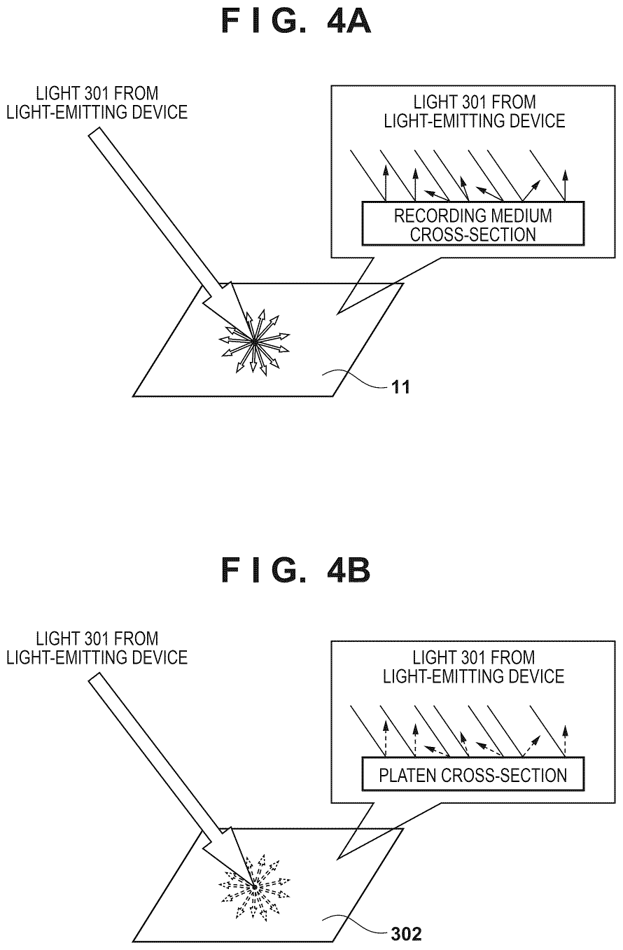

A conveyance mechanism 9 conveys, in the conveyance direction A, the recording medium (recording sheet) 11 supported by a platen 302 (FIG. 4B) having a surface that suppresses a reflection of light, such as a black surface. The carriage 8 is configured to be able to bi-directionally move in a direction crossing the conveyance direction A. The recording head 7 has an ejection orifice surface (nozzle surface) in which a plurality of ejection orifices (nozzles) capable of ejecting ink of respective colors are arranged. The recording head 7 performs a recording operation of recording an image on the recording medium 11 by ejecting ink from the ejection orifices while the carriage 8 is moving.

FIG. 3 is a diagram illustrating an arrangement of a light-sensitive device of the medium edge detection sensor 114.

As described above, the medium edge detection sensor 114 is mounted on the carriage 8 and moves in the directions of arrows B crossing the conveyance direction A. The light-sensitive devices 111 and 112 are arranged side by side in a direction substantially perpendicular to a medium edge face (edge) 201 of the recording medium 11 to be detected. That is, the light-sensitive devices 111 and 112 are disposed on an upstream side and a downstream side with respect to the scanning directions (directions B) of the carriage 8. When an edge of the recording medium 11 is to be detected, the pair of light-sensitive devices (light-sensitive devices 111 and 112) are moved in a direction B substantially perpendicular to the conveyance direction A of the recording medium 11 to detect the edge.

FIGS. 4A and 4B are diagrams for describing a state in which light emitted from a light-emitting device is reflected by the recording medium 11 and a state in which light is reflected by the platen 302.

FIG. 4A illustrates a state in which light emitted from the light-emitting device 110 is reflected by the recording medium 11. When light 301 emitted from the light-emitting device 110 strikes the recording medium 11, the recording medium 11 reflects almost all the light 301 from the light-emitting device 110.

FIG. 4B illustrates a state in which light emitted from the light-emitting device 110 is reflected by the platen 302. Here, the surface of the platen 302 is processed so as not to reflect light. In FIG. 4B, the fact that no light is reflected by the platen 302 is indicated by dotted lines, and the light 301 emitted from the light-emitting device 110 is absorbed by the platen 302 almost entirely without being reflected from the platen 302. As described above, since there is a difference in the amount of reflected light of light 301 emitted from the light-emitting device 110 between the recording medium 11 and the platen 302, the edge of the recording medium 11 can be detected according to the reflection of light emitted from the light-emitting device 110.

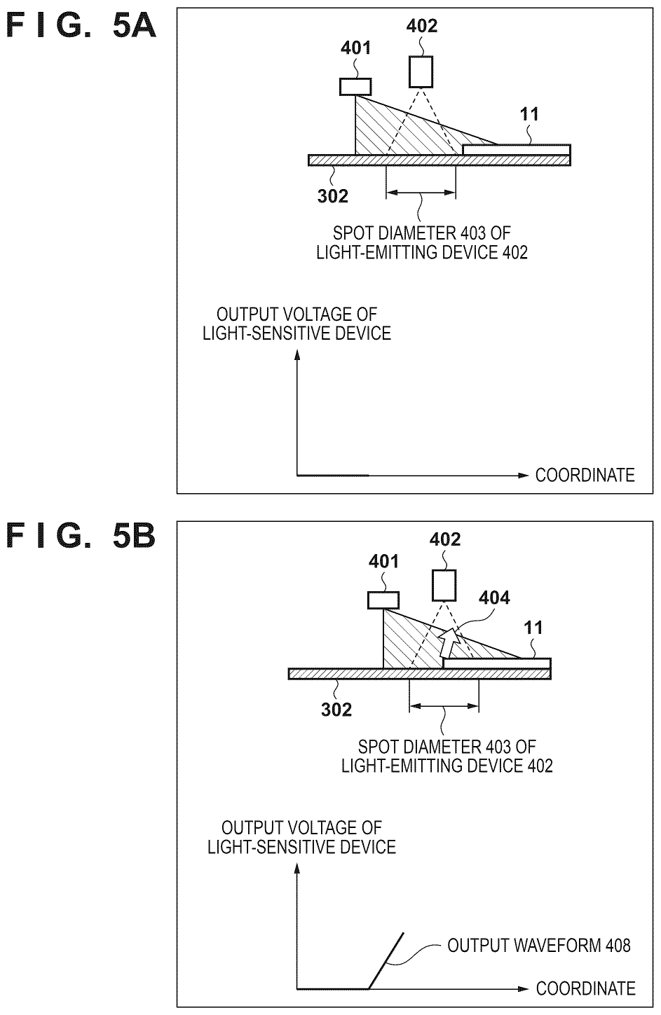

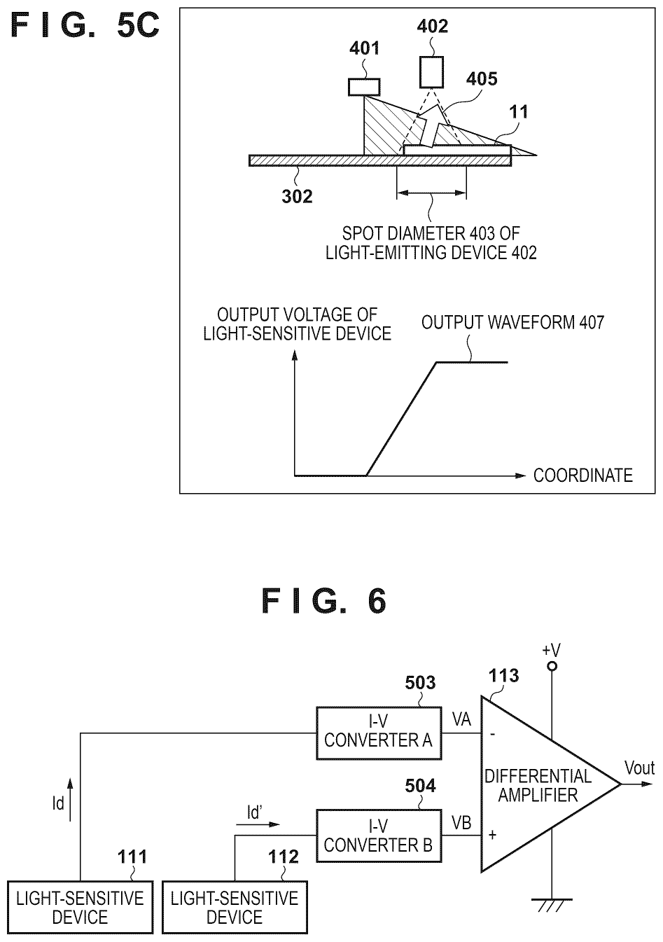

FIGS. 5A through 5C are diagrams for describing typical output waveforms when a reflection of light from the recording medium 11 is detected in one light-sensitive device. Here, FIG. 5A transitions to FIG. 5B and then FIG. 5C in this order.

Light is emitted from a light-emitting device 401 in a direction toward the platen 302 and the recording medium 11. A light-sensitive device 402 detects reflected light 404 within a spot diameter 403 of the light-sensitive device 402, and converts the detected light amount of the reflected light into a voltage to thereby output a voltage corresponding to the detected light amount. When the recording medium 11 moves over the entire area of the spot diameter 403, the voltage outputted from the light-sensitive device 402 is at a maximum.

In FIG. 5A, the light-sensitive device 402 is located directly above the platen 302 and the spot diameter 403 is located on the platen 302. At this time, since the platen 302 does not reflect the light emitted from the light-emitting device 401, the output voltage of the light-sensitive device 402 is OV.

In FIG. 5B, the light-sensitive device 402 is located immediately above the platen 302 and near the edge of the recording medium 11. At this time, since the edge of the recording medium 11 enters the spot diameter 403 of the light-sensitive device 402, the reflected light 404 is generated. The light-sensitive device 402 receives the reflected light 404 and outputs a voltage. At this time, the recording medium 11 takes up approximately half of the spot diameter 403 of the light-sensitive device, so a voltage indicated by output waveform 408 is outputted. At this time, the voltage of the output waveform 408 is approximately half of that when the recording medium 11 completely takes up the spot diameter 403 of the light-sensitive device 402.

In FIG. 5C, the light-sensitive device 402 is located directly above the recording medium 11. Since the recording medium 11 completely takes up the spot diameter 403 of the light-sensitive device 402, reflected light 405 inputted into the light-sensitive device 402 is stronger than that in the state of FIG. 5B. As a result, the output waveform of the light-sensitive device 402 is indicated by an output waveform 407. The voltage that the output waveform 407 indicates is a maximum, and this state is maintained while the recording medium 11 completely takes up the spot diameter 403.

Here, the mechanism is such that the edge of the recording medium 11 is determined when the voltage value of the output waveform exceeds a preset threshold. Therefore, if floating paper or the like occurs when the edge is determined upon the threshold being exceeded, the inclination of the output waveform changes and the position at which the voltage value of the output waveform exceeds the threshold changes, and the position detected as the edge changes.

FIG. 6 is a circuit diagram for describing details of the medium edge detection sensor 114 according to the embodiment.

The outputs of the light-sensitive devices 111 and 112 are respectively inputted into the differential inputs of the differential amplifier 113 via current-to-voltage conversion circuits (I-V converters) A503 and B504. When light reflected from the recording medium 11 enters the light-sensitive devices 111 and 112, photocurrents Id and Id′ flow in turn. The photocurrent Id is inputted into the I-V converter A503, and an output voltage VA thereof is inputted into an inverting input terminal (−) of the differential amplifier 113. Meanwhile, the photocurrent Id′ is inputted into the I-V converter B504 and converted into a voltage value VB, and the voltage value VB is inputted into a non-inverting input terminal (+) of the differential amplifier 113. In this way, an edge detection signal Vout of the recording medium 11 is outputted from the differential amplifier 113.

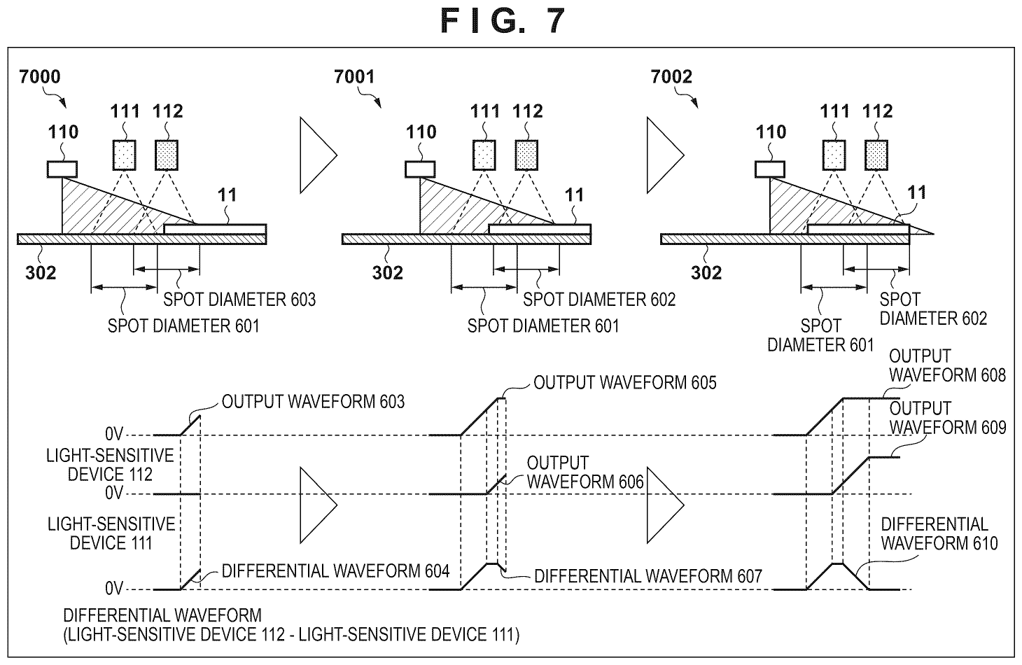

FIG. 7 is a diagram for describing an operation in a case where the medium edge detection sensor 114 according to the embodiment is used, and an example of output waveforms of the medium edge detection sensor 114. In FIG. 7, reference numerals 7000 to 7002 indicate measurement states, and transition is from the state 7000 to 7001 and then 7002 in this order. It is assumed that the light-sensitive device 112 is positioned on the upstream side in the conveyance direction of the recording medium 11 and the light-sensitive device 111 is positioned on the downstream side in the conveyance direction of the recording medium 11.

In a state 7000, the recording medium 11 is not contained in a spot diameter 601 of the light-sensitive device 111, and the recording medium 11 is contained in approximately half of a spot diameter 602 of the light-sensitive device 112. Therefore, the output of the light-sensitive device 111 is OV, and the output of the light-sensitive device 112 is indicated by an output waveform 603. At this time, the differential between the output of the light-sensitive device 112 and the output of the light-sensitive device 111 results in a differential waveform 604.

Next, in a state 7001, the recording medium 11 takes up approximately half of the spot diameter 601 of the light-sensitive device 111, and the recording medium 11 completely takes up the spot diameter 602 of the light-sensitive device 112. Therefore, the output of the light-sensitive device 111 is indicated by an output waveform 606, and the output of the light-sensitive device 112 is indicated by an output waveform 605. When the differential between the output waveform 605 and the output waveform 606 is taken, it results in a differential waveform 607.

Next, in a state 7002, the recording medium 11 completely takes up both the spot diameter 601 of the light-sensitive device 111 and the spot diameter 602 of the light-sensitive device 112. Therefore, the output of the light-sensitive device 111 is indicated by an output waveform 609, and the output of the light-sensitive device 112 is indicated by an output waveform 608. The differential between the output waveform 609 and the output waveform 608 results in a differential waveform 610. As described above, by taking the differential of the outputs of the light-sensitive devices 111 and 112, a pulse can be generated only in the vicinity of the edge of the recording medium 11.

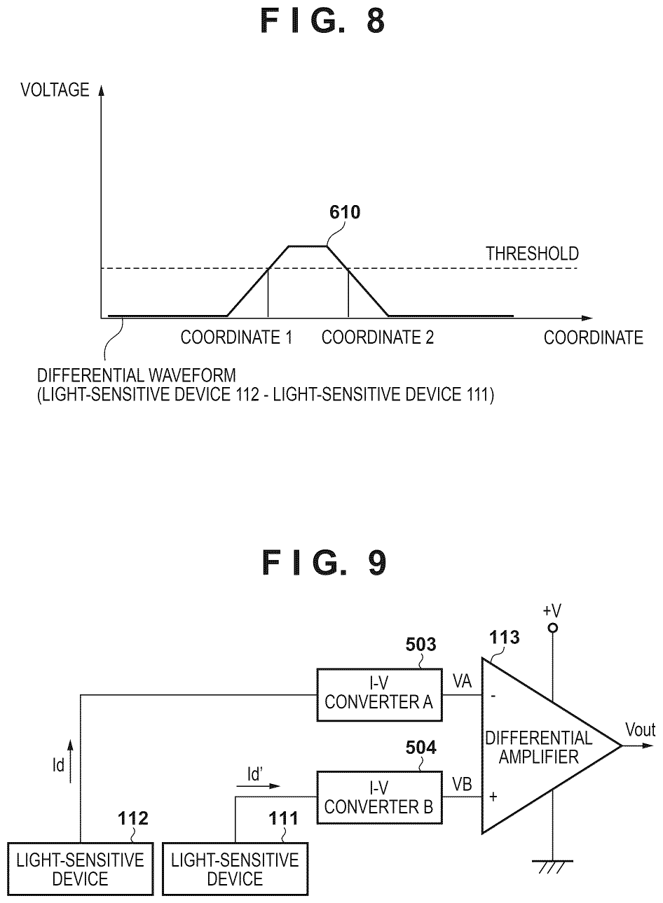

FIG. 8 is a diagram for describing a method of obtaining a position of the edge of a recording medium from the output waveforms of the light-sensitive devices 111 and 112 in the embodiment.

When the conveyed recording medium 11 reaches a position where it can be detected by the light-sensitive device 112 (within the spot diameter 602), the light-sensitive device 112 detects the recording medium 11 and outputs the output waveform 603 (state 7000 in FIG. 7). Then, when the conveyed recording medium 11 reaches a position where it can be detected by the light-sensitive device 111 (within the spot diameter 601), the light-sensitive device 111 detects the medium and outputs the output waveform 606 (state 7001 in FIG. 7). Further, when the conveyed recording medium 11 enters a position where the light-sensitive device 111 can be detected (within the spot diameter 601), the light-sensitive device 111 and the light-sensitive device 112 detect the recording medium 11 and output the output waveforms 608 and 609 (state 7002 in FIG. 7).

In these states, the differential waveform 610 is generated by detecting a differential waveform of the output waveform of the light-sensitive device 112 and the output waveform of the light-sensitive device 111. The position of the edge of the recording medium 11 is calculated from a first coordinate (coordinate 1) when the differential waveform 610 exceeds a predetermined threshold voltage and a second coordinate (coordinate 2) when the differential waveform 610 falls below the predetermined threshold voltage. For example, a center coordinate ((coordinate 1+coordinate 2)/2) of the first coordinate and the second coordinate is defined as the edge of the recording medium 11. However, the present disclosure is not limited to this.

FIG. 9 is a circuit diagram for describing a modification example of the medium edge detection sensor 114 according to the embodiment.

Here, with respect to the detailed view of the medium edge detection sensor illustrated in FIG. 6, the light-sensitive devices 111 and 112 connected to the differential amplifier 113 are connected by swapping + and −. As in FIG. 6, the outputs of the light-sensitive devices 111 and 112 are respectively connected to the differential amplifier 113 via I-V converters B504 and A503. When light reflected from the recording medium 11 enters the light-sensitive devices 111 and 112, photocurrents Id and Id′ flow in turn. The photocurrent Id from the light-sensitive device 112 is converted into a voltage value VA by the I-V converter A503 and inputted into an inverting input terminal (−) of the differential amplifier 113. The photocurrent Id′ from the light-sensitive device 111 is converted into a voltage value VB by the I-V converter B504 and inputted into a non-inverting input terminal (+) of the differential amplifier 113. In this way, the differential amplifier 113 outputs recording medium edge detection signal Vout.

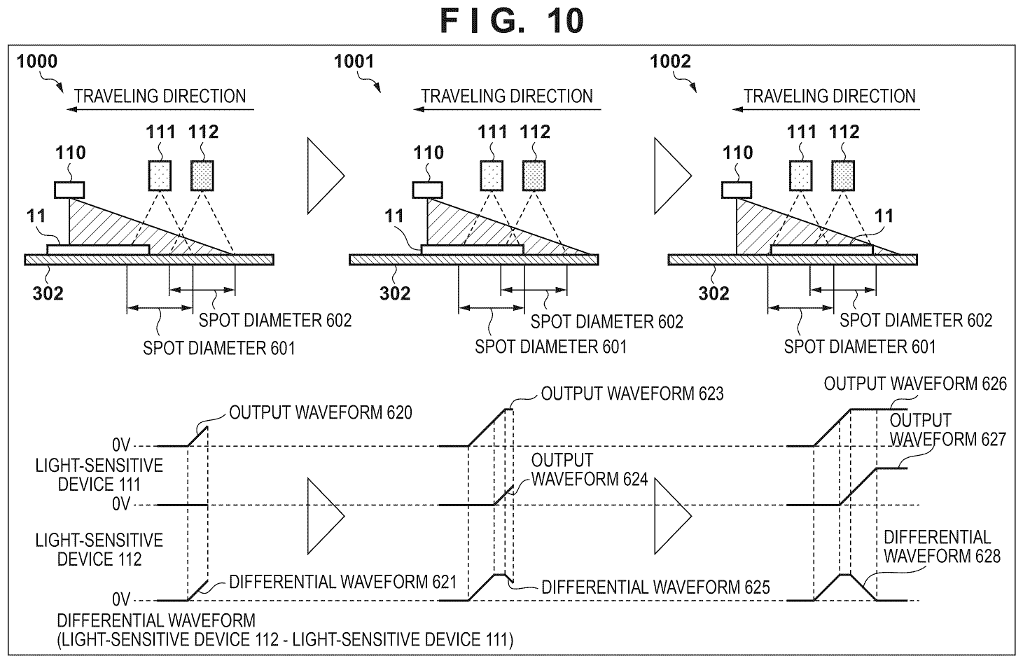

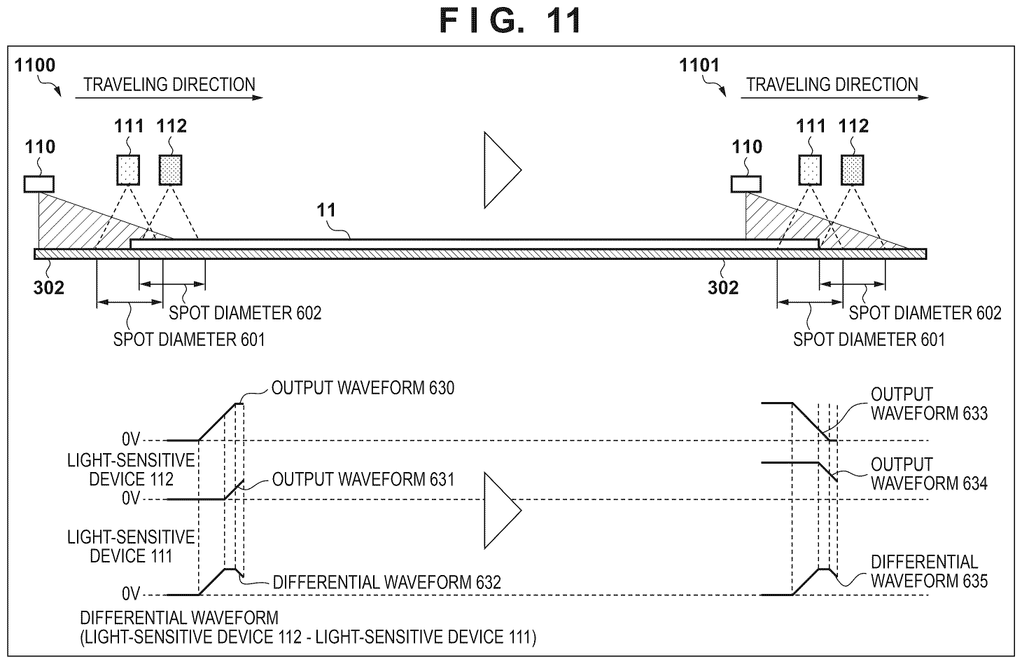

FIG. 10 is a diagram for describing an operation in a case where the medium edge detection sensor 114 according to the embodiment is used, and an example of output waveforms of the medium edge detection sensor 114. FIG. 10 is a diagram illustrating a case where the traveling direction of the carriage 8 is opposite to the operation described in FIG. 7. Therefore, in the case of FIG. 10, the light-sensitive device 111 detects the recording medium 11 first, oppositely to the case of FIG. 7.

The traveling direction of the medium edge detection sensor 114 is calculated by the main controller 101 from the position of the carriage 8 obtained by the encoder sensor 107. FIG. 10 illustrates a case where, in regards to the traveling direction of the light-sensitive device 111 and the light-sensitive device 112, the order in which the recording medium 11 enters the spot diameter 601 and then the spot diameter 602 is opposite to the order in FIG. 7. A circuit in which the voltages are inputted into the differential amplifier 113 is illustrated in FIG. 9. Similarly to FIG. 7, reference numerals 1000 to 1002 indicate measurement states, and transition is from the state 1000 to 1001 and then 1002 in this order.

In a state 1000, the recording medium 11 is not contained in the spot diameter 602 of the light-sensitive device 112, and the recording medium 11 takes up approximately half of the spot diameter 601 of the light-sensitive device 111. In this state, the output of the light-sensitive device 112 is OV, and the output of the light-sensitive device 111 is indicated by an output waveform 620. Here, the differential between the outputs of the light-sensitive device 111 and the light-sensitive device 112 is shown by a differential waveform 621.

Next, in a state 1001, the recording medium 11 takes up approximately half of the spot diameter 602 of the light-sensitive device 112, and the recording medium 11 completely takes up the spot diameter 601 of the light-sensitive device 111. In this state, the output of the light-sensitive device 112 is indicated by an output waveform 624, and the output of the light-sensitive device 1112 is indicated by an output waveform 623. As a result, the differential between the output waveform 623 and the output waveform 624 is shown by a differential waveform 625.

Next, in a state 1002, the recording medium 11 completely takes up both the spot diameter 602 of the light-sensitive device 112 and the spot diameter 601 of the light-sensitive device 111. In this state, the output of the light-sensitive device 111 is shown by an output waveform 626, and the output of the light-sensitive device 112 is shown by an output waveform 627. As a result, the differential between the output waveform 626 and the output waveform 627 results in a differential waveform 628.

The output of the light-sensitive device whose spot diameter first enters the recording medium 11 is inputted into the non-inverting input terminal (+) of the differential amplifier 113 with respect to the direction of travel of the medium edge detection sensor 114. Then, the output of the light-sensitive device whose spot diameter thereafter enters the recording medium 11 is inputted into the inverting input terminal (−) of the differential amplifier 113. Thus, by taking the differential of these two voltages, it is possible to obtain a differential waveform similar to the differential waveform 610 illustrated in FIG. 8. That is, the outputs of the light-sensitive devices to be inputted into the + and − input terminals of the differential amplifier 113 are switched according to the traveling direction of the medium edge detection sensor 114. In this way, regardless of the direction of travel of the medium edge detection sensor 114, the differential waveform 610 can be obtained and the position of the edge of the recording medium 11 can be calculated. However, although in the above description the outputs of the light-sensitive devices are switched, the connections of the I-V converters 503 and 504 and the differential amplifier 113 may be swapped, and there is no limitation to the connection illustrated in FIG. 9.

FIG. 11 is a diagram for describing an operation when both edges of the recording medium 11 are detected using the medium edge detection sensor 114 according to the embodiment. Reference numerals 1100 to 1101 indicate measurement states, and transition is from the state 1100 to 1101 in this order. It is assumed that the connections between the light-sensitive devices 111 and 112 and the differential amplifier 113 are set to the state illustrated in FIG. 6 by the main controller 101 based on the position of the previously-described carriage 8 with respect to the traveling direction.

In a state 1100, the recording medium 11 takes up approximately half of the spot diameter 601 of the light-sensitive device 111, and the recording medium completely takes up the spot diameter 602 of the light-sensitive device 112. At this time, the output of the light-sensitive device 112 is shown by an output waveform 630, and the output of the light-sensitive device 111 is shown by an output waveform 631. When the differential between the output waveform 630 and the output waveform 631 is taken, it results in a differential waveform 632. This is the same state as the state 7001 in FIG. 7, and the differential waveform 607 of FIG. 7 and the differential waveform 632 of FIG. 11 are the same. Although not illustrated in FIG. 11, the transition of the differential waveform from the state 7000 to 7002 in FIG. 7 is also the same in FIG. 11. In this way, the position of the left edge of the recording medium 11 is calculated from the differential waveform 632 outputted according to the movement of the medium edge detection sensor 114.

After the position of the left edge of the recording medium 11 is calculated, the connections between the light-sensitive devices 111 and 112 and the differential amplifier 113 are changed to what is illustrated in FIG. 9 from those in FIG. 6. Thereafter, the medium edge detection sensor 114 transitions to the state 1101. In the state 1101 of FIG. 11, the spot diameter 602 of the light-sensitive device 112 exits the recording medium 11 and completely takes up the platen 302, and the recording medium 11 takes up half of the spot diameter 601 of the light-sensitive device 111. At this time, the output of the light-sensitive device 111 is shown by an output waveform 634, the output of the light-sensitive device 112 is shown by an output waveform 633, and a differential waveform 635 results when the differential between the output waveform 633 and the output waveform 634 is taken. Although not illustrated in FIG. 11, in conjunction with the medium edge detection sensor 114 moving in the traveling direction towards the right edge of the recording medium 11 in FIG. 11, the transition of the differential waveform is the same as in FIG. 8.

In this way, the connections of the light-sensitive devices 111 and 112 to the differential amplifier 113 are selected in accordance with the traveling direction of the medium edge detection sensor 114. That is, in FIG. 11, the positions of both edges of the recording medium 11 can be detected by, after detecting one side of the recording medium 11, for example, the left edge of FIG. 11 by using the circuit diagram as shown in FIG. 6, swapping the connections of the light-sensitive devices 111 and 112 to the differential amplifier 113 as shown in FIG. 9. Also, while description of detection of the left and right edges of the recording medium 11 was given in FIG. 11, the detection of edges of the recording medium 11 is not limited to the left and right, or top and bottom edges, or the like. Also, for example, even when a plurality of recording mediums 11 are arranged in parallel to the traveling direction of the carriage 8, both edges of the plurality of recording mediums 11 in the traveling direction of the carriage 8 can also be detected by swapping the connections of the light-sensitive devices 111 and 112 to the differential amplifier 113.

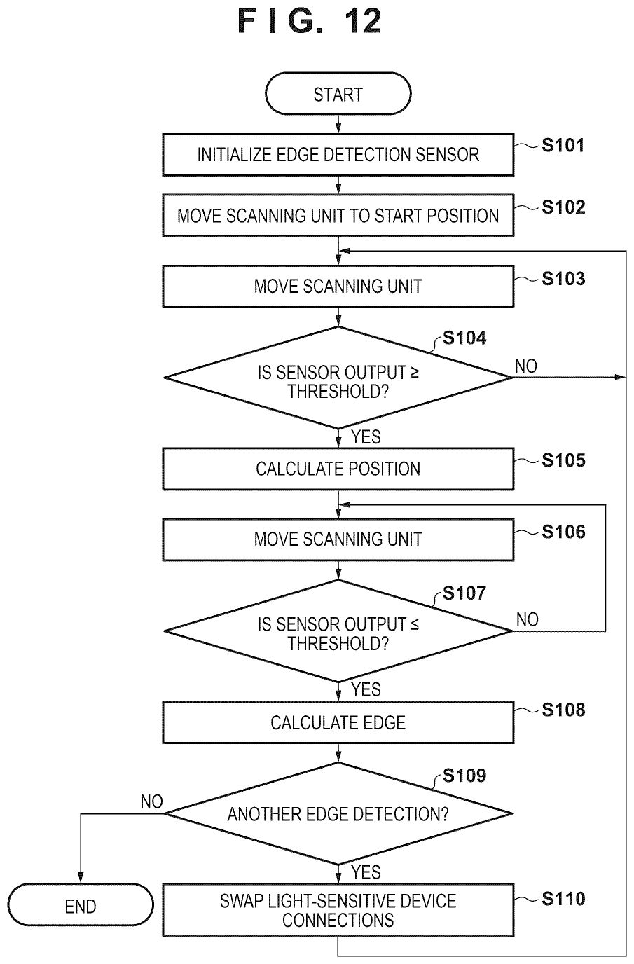

FIG. 12 is a flowchart for describing a process of detecting an edge of a recording medium using the medium edge detection sensor 114 in the recording apparatus according to the embodiment of the present disclosure. This process is started, for example, in a case where the power supply of the recording apparatus is turned on, there is a need to detect an edge of the recording medium, or the like. The process described in this flowchart is realized by the CPU 101a of the main controller 101 executing a program deployed to the RAM 102.

First, in step S101, the CPU 101a performs an initialization process of the medium edge detection sensor 114 such as setting connections of the medium edge detection sensor 114 (FIG. 6 or FIG. 9) and turning on the sensor power supply. The medium edge detection sensor 114 is illustrated in FIGS. 6 and 9. The processing proceeds next to step S102, the CPU 101a moves the scanning unit (also referred to as the carriage 8 in the above description) to a scanning detection start position. At this time, step S103 may be skipped in a case where the scanning unit is already at the start position when the medium edge detection sensor 114 has been turned on. When the scanning unit has moved to the start position in this manner, the processing proceeds to step S103, and the scanning unit is caused to move to detect the edge of the recording medium 11.

Next, the processing proceeds to step S104, and the CPU 101a determines whether or not an output value of the medium edge detection sensor 114 (previously-described differential waveform) becomes greater than or equal to a predetermined threshold in accordance with the scanning of the scanning unit (carriage 8), and if the output is less than or equal to the threshold, the processing proceeds to step S103 and movement of the scanning unit is continued. When the output value of the medium edge detection sensor 114 becomes greater than or equal to the threshold, the processing proceeds to step S105, and the CPU 101a calculates scanning position information (the first coordinate) of the scanning unit for the time when the output value of the medium edge detection sensor 114 became greater than or equal to the threshold. Then, the processing proceeds to step S106 and the CPU 101a moves the scanning unit until the output value of the medium edge detection sensor 114 becomes less than or equal to the threshold in step S107. When the output value of the medium edge detection sensor 114 becomes less than or equal to the threshold in step S107, the processing proceeds to step S108, and the CPU 101a calculates scanning position information (the second coordinate) of the scanning unit for the time when the output value of the medium edge detection sensor 114 became less than or equal to the threshold. Then, the position of the edge of the recording medium 11 is obtained based on the first coordinate obtained in step S105 and the second coordinate. Here, for example, an intermediate position between the first coordinate and the second coordinate is obtained as an edge. However, the position of the edge is not limited to the intermediate point between the first coordinate and the second coordinate, and, for example, a position obtained by a 6:4 division, or the like, of the distance between the first coordinate and the second coordinate, for example, may be set as a position corresponding to a preset ratio.

Next, the processing proceeds to step S109, and it is determined whether another edge (e.g., state 1101 in FIG. 11) is to be detected in the case of detecting both edges of the recording medium 11. Then, when another edge is to be detected, the processing proceeds to step S110, and the CPU 101a performs swapping of the light-sensitive devices by, for example, swapping the connections of the light-sensitive devices or the like as illustrated in FIGS. 6 to 9, and the processing proceeds to step S103 and the scanning unit is moved. Also, the CPU 101a ends this process in a case where the detection operation is to be ended in a case where another edge is not to be detected in step S109, for example.

As described in the foregoing description of FIG. 11, in a case where an edge or both edges of a plurality of recording mediums 11 are to be detected, operations of step S103 to step S110 of the flowchart are repeated to detect the edges of the plurality of recording mediums.

The timing at which the operation for detecting the edge of recording medium is performed can be discretionarily set, for example, in a case where the detection operation is executed prior to printing or in a case where the edge detection is performed together with a printing operation. For example, when printing on the entire surface of the recording medium 11 without any margin, printing is performed over a larger region than that of the recording medium 11 so that the entire surface can be printed even if the recording medium 11 deviates slightly. However, in such a case, there is a possibility that the platen 302 may be stained by ink due to printing a region outside of that of the recording medium 11. In order to prevent ink-staining of the platen 302, the edges of recording medium are accurately detected prior to printing to correct for the positional deviation of the recording medium 11, and configuration is such that it is possible to print only in the region of the recording medium 11 when printing the entire surface without margins. In a case where the recording medium 11 is placed in a skewed manner or the like, by detecting the edges of recording medium during printing, it becomes possible to print while correcting a deviation of an image due to skewing of the recording medium or the like.

The recording medium 11 is not limited to a rectangular medium such as printing paper, and, for example, in a case where a medium having a triangular shape, a polygonal shape, a circular shape, or the like is assumed, there is the effect that it becomes possible to print the entire surface of the recording medium by detecting the edges of the recording medium. Further, it is possible to improve print quality by accurately detecting the edges of a recording medium even outside of the above-described examples.

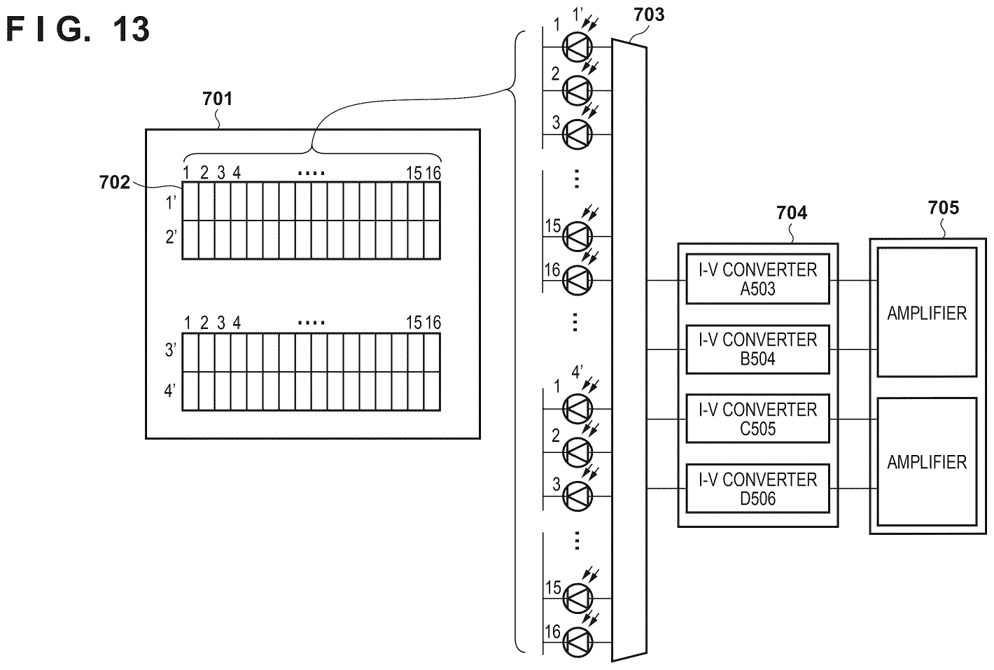

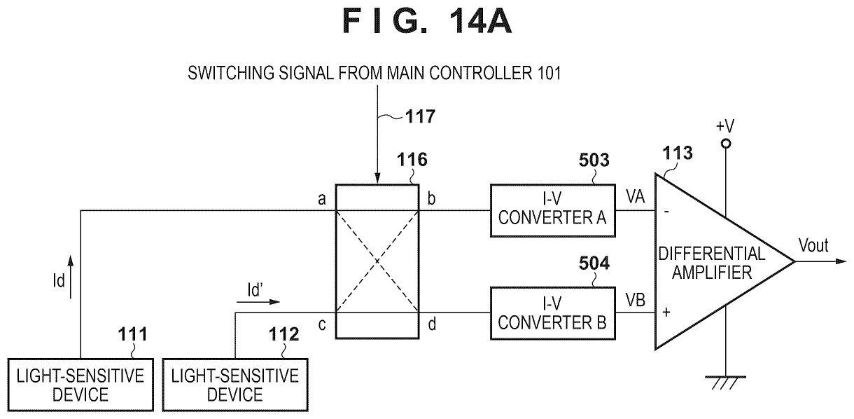

FIG. 13 is a diagram for describing an example of the medium edge detection sensor 114 according to the embodiment.

A plurality of sensors (light-sensitive devices) 702 are arranged in a sensor unit 701. FIG. 13 illustrates the sensor unit 701 comprising a total of 64 sensors in which the sensors are arranged in 16×4 rows. Each sensor 702 is connected by a line to a selector 703 in the sensor unit 701, and the sensor 702 that outputs can be discretionarily selected by the selector 703. The selector 703 can bundle outputs of the plurality of sensors 702 and output the bundling of outputs, and the number of sensors 702 and positions of the sensors 702 can be discretionarily selected. For example, the outputs of the 1st to the 16th sensors of the third row may be bundled and connected to the selector 703 as a light receiving unit, and the outputs of the odd-numbered sensors such as the 1st, 3rd, 5th, and 7th sensors of the 1st row may be selected as a light receiving unit. Further, it is possible to select a light receiving unit by discretionarily setting the positions and the number of the sensors to be selected, such as by selecting the output of the first sensor in each of rows 1′ to 4′ as the light receiving unit. By allowing an arbitrary number of sensors of the plurality of sensors bundled in this manner to be selected as the light receiving unit, the surface area of the light receiving unit can be increased artificially, and therefore an improvement in the sensitivity of the light receiving unit, or the like, can be realized.

The outputs of the selector 703 are connected to I-V converters A503, B504, C505, and D506 arranged in an I-V converter 704 in the sensor unit 701. This allows the selector 703 to discretionarily select which I-V conversion that the output of any one of sensors 702 or a group of multiple sensors 702 is to be connected to. Outputs of the I-V converter 704 are connected to an amplifier unit 705, and amplified output can be obtained from the amplifier unit 705. The amplifier unit 705 includes a rough adjustment amplifier, a fine tuning amplifier, a differential amplifier, and the like, and it can be discretionarily selected which amplifier is used, and it is possible to discretionarily select even a combination of amplifiers. However, the configuration of the amplifier unit 705 is not limited to what is described above, and in addition to the case where a plurality of amplifiers are arranged in the amplifier unit 705 as described above, for example, one type of amplifier unit may be arranged or more types of amplifier units may be arranged.

Thus, for example, the swapping of the connections of the light-sensitive devices in step S110 of FIG. 12 described above can be realized by changing the light-sensitive device selected by the selector 703.

In FIG. 13, the selector 703, the I-V converter 704, and the amplifier unit 705 are built into the sensor unit 701. However, the sensor unit 701 may include only the sensors 702, and the selector 703, the I-V converter 704, and the amplifier unit 705 may be configured as external circuitry. As an example of a combination when detecting the edge of the recording medium, for example, the outputs of the first sensor in the 1′ column and the first sensor in the 2′ column of the sensors 702 are selected by the selector 703 and are connected to the I-V converter A503 and the I-V converter B504 of I-V converter 704, respectively. Then, these outputs are inputted into the differential amplifier of the amplifier unit 705, and it is possible to perform the operation of the edge detection described above with reference to FIG. 6 and the like according to the output obtained from the amplifier unit 705. As described above, the positions and the number of sensors 702 used for detecting the edge of recording medium can be discretionarily selected, so that the detection can be performed assuming various cases when the edge of recording medium is detected.

### Modification Example of Embodiment

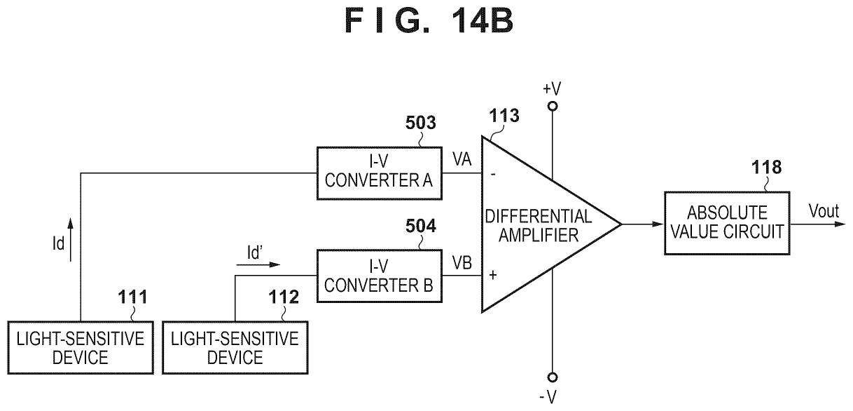

FIG. 14A is a circuit diagram for describing a configuration of the medium edge detection sensor 114 according to an embodiment according to a variation of the embodiment. In FIG. 14A, a switch 116 is added to the configuration of the medium edge detection sensor 114 illustrated in FIG. 6.

A switching signal 117 from the main controller 101 is inputted to the switch 116, and the state is such that the terminals a and b, and c and d of the switch 116 are connected when the switching signal 117 is at a high level, for example. This is the same as the configuration of the medium edge detection sensor 114 in FIG. 6. Meanwhile, the state is such that the terminals a and d, and c and b of the switch 116 are connected when the switching signal 117 is at a low level. The state is such that the terminals a and d, and c and b of the switch 116 are connected. This is the same as the configuration of the medium edge detection sensor 114 in FIG. 9.

By such a configuration, for example, it is possible to set a state in which the connections of the light-sensitive devices 111 and 112 are switched by the CPU 101a switching the switching signal 117 in step S110 of FIG. 12 described above.

FIG. 14B is a circuit diagram for describing a configuration of the medium edge detection sensor 114 according to an embodiment according to another variation of the embodiment. In FIG. 14B, an absolute value circuit (full-wave rectification circuit) 118 is added to the configuration of the medium edge detection sensor 114 illustrated in FIG. 6. Here, the power supply voltage of the differential amplifier 113 is indicated in the cases of +V and −V.

With such a configuration, an edge detection signal Vout having the same polarity can be obtained regardless of the scan direction of the carriage 8 on which the medium edge detection sensor 114 is mounted. Note that configuration may be taken such that the connections between the light-sensitive devices 111 and 112 and the differential amplifier 113 in FIG. 14B are as in FIG. 9, for example.

With such a circuit configuration, for example, there ceases to be a need to switch the connections between the light-sensitive devices 111 and 112 in previously-described step S110 of FIG. 12.

According to the embodiment described above, there is the effect that it is possible to detect the edge of a recording medium with higher accuracy.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-109087, which was filed on Jul. 5, 2024, and which is hereby incorporated by reference herein in its entirety.

What is claimed is:

1. An image forming apparatus, comprising:
a detection unit that has a light-emitting unit configured to emit light towards a recording medium and a plurality of light receiving units configured to detect reflected light of the light; and
one or more controllers including one or more processors and one or more memories, wherein the one or more controllers are configured to:
cause the detection unit to scan in relation to the recording medium;
obtain position information of the detection unit which is caused to scan; and
detect an edge of the recording medium based on signals from the plurality of light receiving units,
wherein the plurality of light receiving units include a first light receiving unit including one or more light-sensitive devices and a second light receiving unit including one or more light-sensitive devices different to those of the first light receiving unit,
the first light receiving unit and the second light receiving unit are arranged to be aligned in a scanning direction of the detection unit,
when an edge of the recording medium is to be detected, the one or more controllers being configured to:
in scanning of the detection unit, detect the edge of the recording medium based on a first coordinate of position information obtained when a differential signal between a first light reception signal outputted from the first light receiving unit and a second light reception signal outputted from the second light receiving unit, which is outputted from a differential amplifier unit, becomes greater than or equal to a threshold and a second coordinate of position information obtained when the differential signal becomes less than or equal to the threshold.

2. The image forming apparatus according to claim 1, wherein when detecting the edge of the recording medium, the one or more controllers detect a center coordinate between the first coordinate and the second coordinate as the edge of the recording medium.

3. The image forming apparatus according to claim 1, wherein when detecting the edge of the recording medium, the one or more controllers detect a position at a division of a distance between the first coordinate and the second coordinate in a predetermined ratio as the edge of the recording medium.

4. The image forming apparatus according to claim 1, wherein the one or more controllers are able to swap the first light reception signal and the second light reception signal for differential inputs of the differential amplifier unit by a switching unit provided between the first light receiving unit, the second light receiving unit, and the differential amplifier unit.

5. The image forming apparatus according to claim 4, wherein the one or more controllers, when detecting the edge of the recording medium, swap the first light reception signal and the second light reception signal by the switching unit in accordance with whether the edge of the recording medium to be detected is on an upstream side of the scanning direction of the detection unit or whether the edge of the recording medium to be detected is on a downstream side of the scanning direction of the detection unit.

6. The image forming apparatus according to claim 1, further comprising:
an absolute value circuit configured to output an absolute value of the differential signal outputted from the differential amplifier unit.

7. The image forming apparatus according to claim 1, further comprising:
a motor as a driving source that causes the detection unit to scan, and
a sensor that detects a driving amount of the motor, wherein the one or more controllers obtain the position information of the detection unit based on output of the sensor.

8. The image forming apparatus according to claim 1, wherein the recording medium is conveyed in a state in which it is supported on a platen having a surface that suppresses a reflection of light emitted from the light-emitting unit.

9. The image forming apparatus according to claim 1, wherein the one or more controllers further select a light receiving unit included in the first light receiving unit and the second light receiving unit from the plurality of light receiving units.

10. An image forming apparatus, comprising:
a detection unit that has a light-emitting unit configured to emit light towards a recording medium and a plurality of light receiving units configured to detect reflected light of the light; and
one or more controllers including one or more processors and one or more memories, wherein the one or more controllers are configured to:
cause the detection unit to scan in a forward direction and a backward direction in relation to the recording medium;
obtain position information of the detection unit which is caused to scan; and
detect an edge of the recording medium based on signals from the plurality of light receiving units,
wherein the plurality of light receiving units include a first light receiving unit including one or more light-sensitive devices and a second light receiving unit including one or more light-sensitive devices different to those of the first light receiving unit,
the first light receiving unit and the second light receiving unit are arranged to be aligned in a scanning direction of the detection unit, and
the image forming apparatus further comprises a differential amplifier unit configured to output a differential signal between a first light reception signal outputted from the first light receiving unit and a second light reception signal outputted from the second light receiving unit, and the one or more controllers being configured to:
when detecting an edge of the recording medium, switch the first light reception signal and the second light reception signal for differential inputs of the differential amplifier of the first light reception signal outputted from the first light receiving unit and the second light reception signal according to a case where the detection unit scans in the forward direction and a case where the detection unit scans in the backward direction.

11. The image forming apparatus according to claim 10, wherein the one or more controllers swap the first light reception signal and the second light reception signal in accordance with whether the edge of the recording medium to be detected is on an upstream side in the scanning direction of the detection unit or whether the edge of the recording medium to be detected is on a downstream side in the scanning direction of the detection unit.

12. A method of detecting an edge of a recording medium in an image forming apparatus having a detection unit that includes a light-emitting unit configured to emit light towards a recording medium, a first light receiving unit including one or more light-sensitive devices, and a second light receiving unit including one or more light-sensitive devices different to those of the first light receiving unit, and that has a plurality of light receiving units configured to detect reflected light of the light, and a scanning unit configured to cause the detection unit to scan in relation to the recording medium, the method comprising:
in scanning by the scanning unit, detecting the edge of the recording medium based on a first coordinate indicating a position of the detection unit when a differential signal between a first light reception signal outputted from the first light receiving unit and a second light reception signal outputted from the second light receiving unit becomes greater than or equal to a threshold and a second coordinate indicating a position of the detection unit when the differential signal becomes less than or equal to the threshold,
wherein the first light receiving unit and the second light receiving unit are arranged to be aligned in a scanning direction of the detection unit.
